(19) United States
(12) Patent Application Publication
(10) Pub. No.: US 2026/0116343 A1
(43) Pub. Date: Apr. 30, 2026

(54) PORTABLE DEVICE AND MODE CONTROL METHOD

(71) Applicant: DENSO CORPORATION, Kariya-city (JP)

(72) Inventor: Koji YASUDA, Kariya-city (JP)

(21) Appl. No.: 19/430,497

(22) Filed: Dec. 23, 2025

Related U.S. Application Data
(63) Continuation of application No. PCT/JP2024/026174, filed on Jul. 22, 2024.

(30) Foreign Application Priority Data
Aug. 1, 2023 (JP) 2023-125811

(51) Int. Cl. B60R 25/40; B60R 25/01; B60R 25/24; G07C 9/00; H02J 50/20

(52) U.S. Cl. CPC B60R 25/406; B60R 25/01; B60R 25/24; G07C 9/00309; H02J 50/20; B60R 2325/101; G07C 2009/00587; G07C 2009/00793; G07C 2009/00984

(57) ABSTRACT

A portable device is provided that functions as a wireless key for a door and operates on a secondary battery. The portable device includes a wireless communicator for performing wireless communication with a system that controls a lock state of the door, and a controller that controls the wireless communicator. The controller is configured to perform, by using the wireless communicator, transmitting an advertise signal being a wireless signal for establishing communication connection with the system, acquiring data indicating a remaining power of the secondary battery, and changing an operating mode of the portable device based on the remaining power. The operating mode relates to transmission of the advertise signal.

### CROSS-REFERENCE TO RELATED APPLICATIONS

This application is a continuation application of International Patent Application No. PCT/JP2024/026174 filed on Jul. 22, 2024, which designated the U.S. and claims the benefit of priority from Japanese Patent Application No. 2023-125811 filed in Japan on Aug. 1, 2023. The entire disclosures of all of the above applications are incorporated herein by reference.

### TECHNICAL FIELD

The present disclosure relates to a portable device that functions as a wireless key for a door.

### BACKGROUND

There is a configuration in which a vehicle and a portable device initiate wireless communication for location determination in response to the vehicle having communication connection with the portable device.

### SUMMARY

According to one aspect of the present disclosure, a portable device functioning as a wireless key for a door and operating on a secondary battery comprises: a wireless communicator for performing wireless communication with a system that controls a lock state of the door; and a controller, including a computer, that controls the wireless communicator. The controller is configured to perform: by using the wireless communicator, transmitting an advertise signal being a wireless signal for establishing communication connection with the system; acquiring data indicating a remaining power of the secondary battery; and changing an operating mode of the portable device based on the remaining power, wherein the operating mode relates to transmission of the advertise signal.

### BRIEF DESCRIPTION OF DRAWINGS

Objects, features and advantages of the present disclosure will become more apparent from the following detailed description made with reference to the accompanying drawings. In the drawings:

FIG. 1 is a diagram illustrating an overview of an electronic key system for a vehicle;

FIG. 2 is a block diagram of an in-vehicle system;

FIG. 3 is a block diagram of a portable device;

FIG. 4 is a block diagram of a wireless power receiver;

FIG. 5 is a flowchart showing an example of controller operation associated with start of wireless charging;

FIG. 6 is a diagram showing an example of user operation for forcible transition to a power saving mode;

FIG. 7 is a sequence diagram illustrating a flow of communications between the vehicle and the portable device;

FIG. 8 is a flowchart for illustrating controller operation when a portable device vibrates;

FIG. 9 Is a flowchart showing another example of controller operation; and

FIG. 10 is a flowchart showing another example of controller operation.

### DETAILED DESCRIPTION

There is a configuration in which a vehicle and a portable device initiate wireless communication for location determination in response to the vehicle having communication connection with the portable device via Bluetooth (registered trademark) Low Energy (hereinafter referred to as Bluetooth LE). In the configuration, the location of the portable device relative to the vehicle is determined by distance-measurement communication using UWB (Ultra Wide Band) communication between a plurality of sensors mounted on the vehicle and the portable device. There is a portable device that operates on a secondary battery such as a lithium-ion battery.

As compared with portable devices that operate on primary batteries, portable devices that operate on secondary batteries have advantage of absence of battery replacement. However, secondary batteries may become un-rechargeable when over-discharged. In order to prolong the life of the secondary battery, it may be desirable that the remaining battery level do not decrease to an end-of-discharge voltage.

In view of the above, it is one of objects of the present disclosure to provide a technology for suppressing degradation of a secondary battery in a portable device that operates on the secondary battery.

According to a first aspect of the present disclosure, a portable device is disclosed that functions as a wireless key for a door and operates on a secondary battery and comprises: a wireless communicator for performing wireless communication with a system that controls a lock state of the door; and a controller that controls the wireless communicator, wherein the controller is configured to perform: by using the wireless communicator, transmitting an advertise signal being a wireless signal for establishing communication connection with the system; acquiring data indicating a remaining power of the secondary battery; and changing an operating mode of the portable device based on the remaining power, wherein the operating mode relates to transmission of the advertise signal.

According to the above configuration, an advertise signal transmission mode (e.g., frequency and transmission power) is changed according to the remaining power of the secondary battery. Therefore, a possibility that the secondary battery reaches an over-discharge state can be reduced, and deterioration of the secondary battery can be suppressed.

According to a second aspect of the present disclosure, a mode control method performed by a portable device that operates on a secondary battery and is configured to function as a wireless key for a door is provided. The mode control method comprises: by using the wireless communicator, transmitting an advertise signal being a wireless signal for establishing communication connection with a system that controls a lock state of the door; acquiring data indicating a remaining power of the secondary battery; and changing an operating mode of the portable device based on the remaining power, wherein the operating mode relates to transmission of the advertise signal.

According to the above mode control method, an advertise signal transmission mode is changed according to the remaining power of the secondary battery, and therefore, it is possible to suppress secondary battery deterioration.

Embodiments of the present disclosure will be described using the drawings. The present disclosure is not limited to the following embodiments. The configurations disclosed below may be implemented with various modifications to the extent that it does not depart from the sprit and scope. Various variations may be implemented in combination as appropriate to the extent that no technical contradictions arise. The present disclosure also includes not-explicitly-stated configurations combining multiple variations. In the following description, parts having like functions may be given like reference symbols and their specific description may be omitted. If only part of the configuration is mentioned, the description elsewhere may apply to the other parts.

### On Overall Configuration

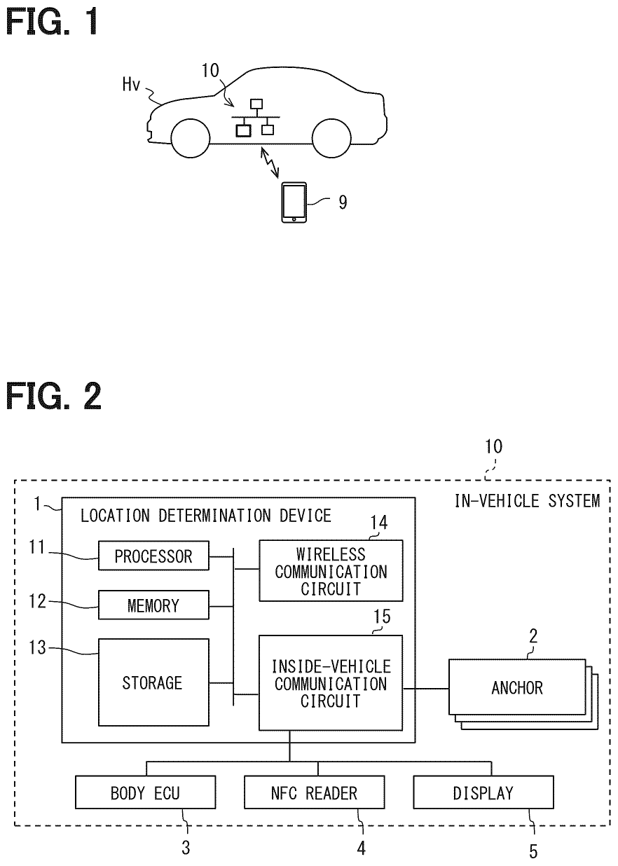

An electronic key system for a vehicle of the present embodiment includes an in-vehicle system 10 and a portable device 9, as shown in FIG. 1. The in-vehicle system 10 is a system installed in a vehicle Hv. The in-vehicle system 10 includes a location determination device 1 and a plurality of anchors 2, as shown in FIG. 2. In the following description, the in-vehicle system 10 and the vehicle Hv may be read interchangeably. The in-vehicle system 10 corresponds to a system that controls a lock state of a door of the vehicle Hv.

The portable device 9 is a wireless communication terminal carried by the user. The portable device 9 is associated with the location determination device 1. In other words, device information of the portable device 9 is registered in the location determination device 1. The device information includes an identification number of the device (hereinafter, device ID). The device ID may be a device address or a Universally Unique Identifier (UUID), etc. Multiple portable devices 9 may be associated with the location determination device 1.

The location determination device 1 is a device that determines the location of the portable device 9 relative to the vehicle Hv. The location determination device 1 and the portable device 9 each include a short-range communication module. The short-distance communication module is a communication module to perform short-distance communication. The short-range communication herein refers to communication that conforms to a given wireless communication standard, where the effective communication range is from 5 m to 50 m, with a maximum of about 100 m. The short-range communication may be Bluetooth (registered trademark) Low Energy (hereinafter Bluetooth LE), Wi-Fi (registered trademark), etc. In the following description and drawings, the short-range communication is referred to also as SRWC (Short Range Wireless Communication). In the present disclosure, signals transmitted and received in the short-range communication may be described as short-range communication signals or SRWC signals.

In the below, the operation of each part will be described using, by way of example, cases where the short-range communication (i.e., SRWC) is Bluetooth LE. Further in the below, the portable device 9 is configured to operate as a peripheral in Bluetooth LE and the location determination device 1 is set to act as a central. The roles of the portable device 9 and the location determination device 1 may be interchangeable.

An anchor 2 is a wireless communication module for implementing distance-measurement communication with the portable device 9. The distance-measurement communication in the present disclosure refers to wireless communication for measuring distances between communication devices. The plurality of anchors 2 and the portable device 9 in the present embodiment are all configured to be able to implement the distance-measurement communication by UWB communication. The UWB communication is a UWB-IR (Ultra Wide Band-Impulse Radio) wireless communication.

The anchor 2 and the portable device 9 are configured to transmit and receive impulse-like radio waves used in the UWB communications (hereafter referred to as impulse signals). An impulse signal used in the UWB communication may be a signal with an extremely short pulse width (e.g., 2 ns) and a bandwidth of 500 MHz (strictly speaking, 499.2 MHz) or more (i.e., ultra-wide bandwidth). UWB signals in the following may be understood as signals exchanged in the UWB communications.

In addition, the in-vehicle system 10 and the portable device 9 are configured to be able to implement Near Field Communication (NFC). NFC herein refers to communication where a communication range is from a few centimeters to several tens of centimeters. NFC also called near field communication, contactless communication, or touch communication. NFC corresponds to a communication method with a sufficiently smaller communication range than SRWC. NFC may have a communication range of less than one-tenth of that of SRWC. Specific NFC standards may be ISO/IEC 18092 (NFCIP-1), ISO/IEC 21481 (NFCIP-2), ISO/IEC 14443, or ISO/IEC 18092. The portable device 9 is configured to operate as a passive device (so-called tag), i.e., a terminal that sends data back based on a request from the vehicle Hv in the NFC communication with the vehicle Hv. The roles of the in-vehicle system 10 and the portable device 9 in the NFC communication can be interchanged.

### In-vehicle System

As shown in FIG. 2, the in-vehicle system 10 includes, in addition to the location determination device 1 and multiple anchors 2, other devices such as a body ECU 3, an NFC reader 4, and a display 5. The location determination device 1 is connected to each of the multiple anchors 2 by a dedicated communication cable. The location determination device 1 is connected to the body ECU 3 via an in-vehicle network. The in-vehicle network is a communication network built inside the vehicle Hv. The standard for the in-vehicle network may be any standard, such as Controller Area Network (CAN is a registered trademark), Ethernet (registered trademark), or FlexRay (registered trademark). The form of connection between devices may be modified as needed.

The location determination device 1 is an ECU that determines a device location in cooperation with the anchor 2. The device location in the present disclosure refers to a location of the portable device 9 relative to the vehicle Hv. Determining the device location corresponds to determining a user location. The device location may be read as the user location. The location determination device 1 controls the operation of the anchor 2.

The location determination device 1 includes a processor 11, a memory 12, a storage 13, a wireless communication circuit 14, and an in-vehicle communicator 15. The processor 11 may be a CPU (Central Processing Unit) or MPU (Micro Processing Unit). The memory 12 may be a volatile storage medium such as RAM (Random Access Memory). The storage 13 is a configuration that includes a non-volatile storage medium such as a flash memory. The storage 13 may store the device ID and anchor data of the portable device 9 and data for authentication. The anchor data is data indicating mounting locations of the plurality of anchors 2 in the vehicle Hv. The data for authentication may be data (e.g., key code) for authenticating the portable device 9.

The wireless communication circuit 14 is a short-range communication module built into the location determination device 1. The wireless communication circuit 14 includes an antenna for short-range communication, a transmission receiving circuit, and a SRWC controller. The transmission receiving circuit is s a circuit that performs signal processing related to modulation and demodulation. The SRWC controller is a microcomputer that executes data processing related to the short-range communication.

The wireless communication circuit 14 is supplied with power from an on-board battery also during off of the power for driving. The wireless communication circuit 14 periodically scans and attempts to connect with the portable device 9 using the power supplied from the on-board battery. The scan refers to being ready to receive the SRWC signal. The wireless communication circuit 14 transmits a connection request to the portable device 9 in response to receiving an advertise signal from the portable device 9, and establishes a communication connection with the portable device 9.

The in-vehicle communicator 15 is a circuit for the processor 11 to communicate with each of the multiple anchors 2. The in-vehicle communicator 15 may include a circuit for the processor 11 to communicate with other in-vehicle devices via the in-vehicle network. The in-vehicle communicator 15 may include a PHY chip or other components compliant with the communication standards of the in-vehicle network.

In response to establishing the communication connection with the portable device 9, the location determination device 1 performs an authentication process by the SRWC. The authentication process may be performed by a challenge-response method or other means. In addition, the location determination device 1 causes each anchor 2 to perform the distance-measurement communication with the portable device 9 upon establishing the communication connection with the portable device 9. The location determination device 1 acquires data indicating a result of the distance-measurement communication from each of the plurality of anchors 2 (hereinafter referred to as distance-measurement result data). The distance-measurement result data includes the ID of the portable device 9 that has performed the distance-measurement and data indicating the distance from the anchor 2 to the portable device 9. A value indicating the distance from the anchor 2 to the portable device 9, determined by the distance-measurement communication, is referred to also as a distance-measurement value.

The location determination device 1 specifies the distance from the vehicle Hv to the portable device 9 (hereinafter also referred to as device distance) based on the distance measurement result data provided by each anchor 2. The location determination device 1 may determine the device distance by combining/integrating the distance measurement values observed by the multiple anchors 2. The device distance may be the minimum of the distance measurement values observed by the multiple anchors 2.

The location determination device 1 may determine whether the portable device 9 is in the vehicle, vicinity area or other area, based on the distance-measurement result data provided by each anchor 2. The vicinity area is the area outside the vehicle and is within a given operating distance from the vehicle Hv. The operating distance may be set at 1.0 m, 1.5 m, 2.0 m, etc. The location determination device 1 may determine whether the portable device 9 is in the vicinity area by comparing the device distance to the operating distance. The location determination device 1 provides the specified location information of the portable device 9 to the body ECU 3.

The anchor 2, as mentioned above, is a device used to implement the distance-measurement communications with the portable device 9. The anchor 2 is configured to implement UWB communications. The in-vehicle system 10 may include the plurality of anchors 2. The anchors 2 may be arranged at the left and right ends of the front bumper and at the left and right ends of the rear bumper. The anchor 2 may be arranged near the driver's seat, on the ceiling of the vehicle, in the trunk, etc. The anchors 2 may be substantially the same in terms of configuration and performance.

The anchor 2 includes an antenna for the UWB communications, a transmission receiving circuit, and a UWB controller. The UWB controller is a microcomputer that executes processes related to the distance-measurement communications. The UWB controller generates distance-measurement result data by conducting the distance-measurement communications with the portable device 9 and transmits (reports) the distance-measurement result data to the location determination device 1. An overview of the distance-measurement communications will be described later.

The body ECU 3 is an electronic control unit (ECU) that controls body system equipment such as headlights, door lock motors, and power window motors. The body ECU 3 controls door unlock/lock based on that (i) the portable device 9 is in the vicinity area, (ii) the portable device 9 has been authenticated, and (iii) a given user action has been taken.

Whether or not the portable device 9 is present in the vicinity area may be determined by referring to the determination result of the location determination device 1. The authentication of the portable device 9 is also performed by the location determination device 1. A user actions for locking/unlocking may be an act of touching a door handle or an act of placing a foot over a detection area formed below the door. Controlling door unlocking/locking corresponds to controlling a lock state of the vehicle Hv. The body ECU 3 can be understood as an ECU that provides a passive entry function in cooperation with the location determination device 1. The passive entry function locks/unlocks the vehicle Hv in response to a given user action on the vehicle Hv.

Thus, the in-vehicle system 10 functions as a system that controls the lock state of the vehicle Hv through the cooperation of the body ECU 3 and the location determination device 1. The body ECU3 may be replaced by an integrated ECU, a zone ECU, or a domain ECU. The body ECU 3 and the location determination device 1 may be integrated. The functional arrangement within the in-vehicle system 10 may be modified as needed.

The NFC reader 4 is a module for implementing NFC. The NFC reader 4 attempts to establish a communication connection with the portable device 9 by transmitting polling commands periodically/when certain events occur. The polling command is used to check whether or not the portable device 9 is present at a location where the NFC reader 4 can communicate. The NFC reader 4 may be arranged to a driver's side outer door handle, a side mirror, a rear window, a pillar, etc. An operating state of the NFC reader 4 may be controlled by the location determination device 1.

The display 5 is a display arranged in the vehicle. The display 5 displays an image according to an instruction signal input from the location determination device 1. The display 5 may display the remaining power notification image described below based on the instruction of the location determination device 1. The display 5 may be an LCD, an OLED, or a head-up display. The display 5 may be configured to be capable of displaying multiple colors.

### Portable Device 9

The portable device 9 is a dedicated device that functions as a wireless key for the vehicle Hv. The portable device 9 may be a device that, when the vehicle Hv is purchased, is transferred to the owner along with the vehicle Hv. The portable device 9 may be understood as one of accessories of the vehicle Hv. The portable device 9 can have any shape, such as a flat rectangular shape, a flat oval shape (so-called fob type), a card shape, etc. The portable device 9 may be called a smart key, a key fob, a key card, an access key, etc. The portable device 9 functions as a key of the vehicle Hv by performing wireless authentication with the location determination device 1 using the SRWC.

The portable device 9 may be a general-purpose information processing terminal that has a SRWC function. The portable device 9 may be a smartphone or a wearable device. The portable device 9 may be paraphrased as a portable device, a user device, or a key device, etc. The Portable devices may not have even a single user-pressable button (i.e., push switch).

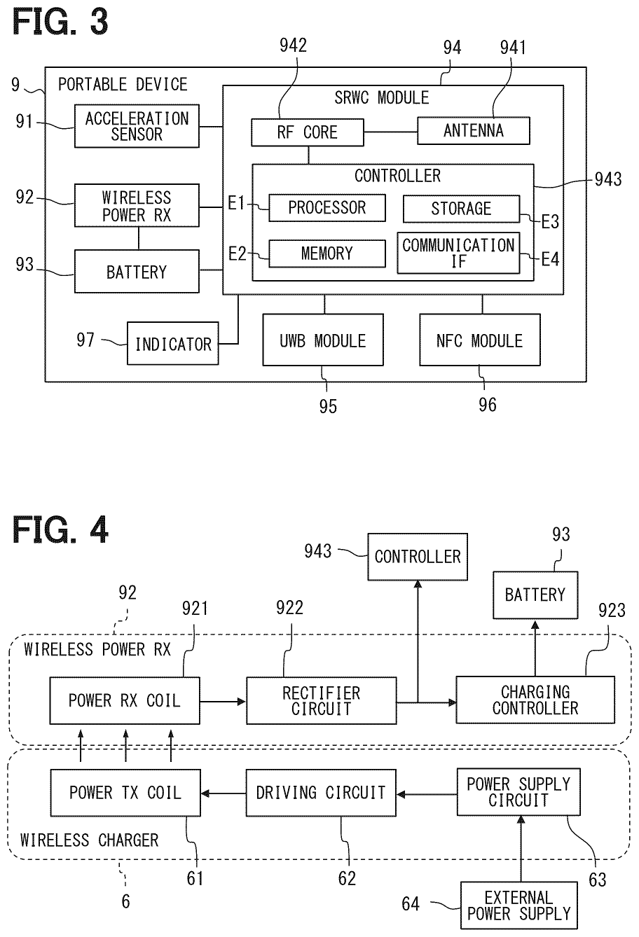

As shown in FIG. 3, the portable device 9 includes an acceleration sensor 91, a wireless power receiver 92, a battery 93, an SRWC module 94, a UWB module 95, an NFC module 96, and an indicator 97. As noted at the beginning, the portable device 9 performs the SRWC with the location determination device 1 of the vehicle Hv and also performs the UWB communication with the anchor 2. The vehicle Hv in SRWC in the following may be read as the location determination device 1 or the in-vehicle system 10. The vehicle Hv in the UWB communication (the distance-measurement communication) may be read as the anchor 2 or the in-vehicle system 10.

The acceleration sensor 91 is a sensor that detects acceleration acting on the portable device 9. The acceleration sensor 91 may include multiple sensing axes. The acceleration sensor 91 may be a 3-axis acceleration sensor. The acceleration sensor 91 detects acceleration at a given interval, such as every 100 milliseconds (10 Hz), and outputs data indicating a result of the detection (hereafter, acceleration data) to the SRWC module 94 and the controller 943. The acceleration data may include a detected acceleration value for each axis direction. The acceleration detected by the acceleration sensor 91 represents magnitude of vibration acting on the portable device 9, in other words, the intensity of the user's movement. The acceleration may be replaced with vibration or motion. The acceleration sensor 91 corresponds to a vibration sensor.

In another embodiment, the acceleration sensor 91 may be a uniaxial or biaxial acceleration sensor. The portable device 9 may include a gyro sensor in place of/along with the acceleration sensor 91, as a sensor for detecting vibrations. The acceleration in the following description may be interpreted as the maximum of an absolute value of the acceleration for each detected axis. The acceleration sensor 91 may be configured to output an activation signal to controller 943 upon detecting the acceleration exceeding a given activation threshold. The activation signal may be a signal having a given bit pattern or a signal indicating that the detected value of acceleration is above a given value (in other words, acceleration data).

The wireless power receiver 92 is a configuration that receives electric power transmitted from a wireless charger 6 and charges the battery 93, as shown in FIG. 4. The wireless charger 6 is a device for charging, independent of the portable device 9. The wireless charger 6 corresponds to a wireless charging device. The wireless charger 6 includes a power transmission coil 61, a drive circuit 62, and a power supply circuit 63. The power transmission coil 61 is a coil for providing electric power to the portable device 9 by electromagnetic coupling with a power receiving coil 921 of the portable device 9. The power transmission coil 61 is also referred to a primary coil and the power receiving coil 921 is also referred to as a secondary coil. The drive circuit 62 is a circuit that generates an alternating current of a given frequency based on the power supplied by the power supply circuit 63 and flows it to the power transmission coil 61. The power supply circuit 63 is a circuit that adjusts the voltage supplied by the external power source 64 to a voltage suitable for the operation of the drive circuit 62. The external power source 64 may be a home power outlet, mobile battery, or car battery.

The frequency of the electromagnetic waves used for wireless charging (hereinafter, the charging frequency) may be any frequency. The charging frequency may be a frequency that belongs to the 110 kHz to 205 kHz bandwidth used in the Qi standard. The portable device 9 in the present embodiment is compatible with the Qi standard. Of course, the portable device 9 may be configured to be wirelessly rechargeable using the AirFuel Inductive/Resonant method.

The wireless power receiver 92 includes a power receiving coil 921, a rectifier circuit 922, and a charge controller 923. The power receiving coil 921 is a coil for receiving power transmitted wirelessly from the wireless charger 6 by electromagnetic coupling with the power transmission coil 61. The rectifier circuit 922 converts the power received by the receiving coil 921 into DC power (e.g., DC current). The output voltage of rectifier circuit 922 is input to the charge controller 923 and the controller 943. The charge controller 923 charges the power, input from the rectifier circuit 922, to the battery 93.

The battery 93 is a battery that stores the power provided for the operation of the portable device 9. The battery 93 is chargeable and dischargeable (i.e., a secondary battery). The battery 93 may be a lithium-ion secondary battery. Of course, the battery 93 may be a rechargeable lithium-ion polymer battery, a nickel-cadmium battery, or a nickel-metal hydride secondary battery. An end-of-discharge voltage is set for the battery 93. The end-of-discharge voltage is the lowest value of discharge voltage at which discharge can be safely performed. The state in which the voltage is below the end-of-discharge voltage corresponds to over-discharge. The controller 943, described below, monitors the output voltage of the battery 93 and controls the operation of the portable device 9 to prevent from reaching an over-discharged state.

The SRWC module 94 is a short-range communication module of the portable device 9. The SRWC module 94 corresponds to a wireless communicator and a first communicator. The SRWC module 94 corresponds to a wireless communicator. The SRWC module 94 includes an antenna 941, a radio frequency (RF) core 942, and a controller 943. The SRWC module 94 also includes a clock oscillator that generates a clock for the controller 943 to operate. The controller 943 corresponds to a controller.

The antenna 941 is an antenna element for transmitting and receiving radio waves in a frequency band used for SRWC (in this case, the 2.4 GHz band). The RF core 942 is a circuit module that performs processing related to transmitting and receiving wireless signals. The RF core 942 may include a modulation circuit, a demodulation circuit, a frequency conversion circuit, an amplification circuit, and a local oscillator. The RF core 942 is connected to the antenna 941 and the controller 943. The RF core 942 demodulates the signal received by an antenna 21 and provides it to the controller 943. The RF core 942 modulates the transmission data input from the controller 943 and radiates it as radio waves from the antenna 21. The RF core 942 may be provided as an IC chip (i.e., a transmitter/receiver IC).

The controller 943 is a microcomputer that controls the operation of the SRWC module 94 and as a result, the portable device 9 as a whole. The controller 943 includes a processor E1, a memory E2, a storage E3, and a communication interface E4. The Processor E1 may be a CPU. The memory E2 is a volatile storage medium such as RAM. The storage E3 is a storage device including a non-volatile storage medium such as flash memory. The storage E3 may include several types of storage media, such as ROM (Read Only Memory) and flash memory. The communication interface E4 is a circuit module that allows the processor E1 to communicate with other components, such as the UWB module 95 and the NFC module 96.

A device control program is stored in storage E3. The device control program is a program that includes instructions for controlling an operating mode. The device control program may be interpreted as a program corresponding to a mode control method.

In addition, data for communication is stored in storage E3. The data for communication is the data to implement wireless communication with the vehicle Hv. The data for communication may include a parameter received from the location determination device 1 by pairing, such as the device ID of the location determination device 1. The data for communication may include the identification number of the vehicle Hv (hereinafter, vehicle ID). The vehicle ID corresponds to an identification information of the vehicle/vehicle-mounted system that is a communication target. The vehicle ID may be paraphrased as the system ID. The vehicle ID may be a Vehicle Identification Number (VIN). The data for communication may include a key code used for the wireless authentication with the vehicle Hv.

The SRWC module 94 is configured to enable the implementation of an advertise. The advertise is a process of transmitting an advertise signal using a given channel. The advertise signal is a wireless signal that notifies another device of the presence of the host-device. One advertise may be a process of transmitting the advertise signal once in each of the three channels (37Ch (2402 MHz), 38Ch (2426 MHz), and 39Ch (2480 MHz)) among the 40 channels (0Ch to 39Ch) available in Bluetooth LE. The Advertise may be rephrased as advertising or advertisement. If the SRWC module 94 receives a connection request from the vehicle Hv in response to the advertise, the SRWC module 94 establishes the communication connection with the vehicle Hv. The SRWC module 94 can be understood as a module that allows the portable device 9 to implement data communication with the vehicle Hv. The controller 943 may perform the authentication process (i.e., wireless authentication) by SRWC upon establishment of the communication connection with vehicle Hv. Details of the SRWC module 94 and controller 943 will be described separately later.

The UWB module 95 is a communication module for implementing UWB communication. The UWB module 95 corresponds to a second communicator. The UWB module 95 outputs the received data to the controller 943. The UWB module 95 also transmits a UWB signal corresponding to the transmission data input from the controller 943. The UWB module 95 is configured to become active perform the distance-measurement communication, and stop operation based on instructions from the controller 943.

The distance-measurement communication is used to measure a propagation time (in other words, time of flight) of radio waves from the anchor 2 to the portable device 9. The distance-measurement communication may include a step where the portable device 9 broadcasts a pole signal and ta step where the anchor 2 transmits a response signal in response to receiving the pole signal. The distance-measurement communication may also include a step where the portable device 9 transmits a final signal in response to receipt of the response signal. The poll signal is a signal that requires a responder to transmit a response (response). The response signal may be paraphrased as an answer signal.

In the distance-measurement communications, the portable device 9 measures a round-trip time (hereinafter RTT), which is an elapsed time from transmitting the poll signal toward the vehicle Hv to receiving the response signal from the vehicle Hv. RTT is an abbreviation of Round-Trip Time. The portable device 9 may calculate the distance measurement value from the RTT measured by executing the distance-measurement communication and transmit it to the location determination device 1 by the SRWC. The anchor 2 may calculate the distance measurement value based on the time elapsed from transmitting the response signal to receiving the final signal from the portable device 9, and report it to the location determination device 1.

In the distance-measurement communication of the present embodiment, the portable device 9 operates as an initiator and the vehicle Hv (actually each anchor 2) operates as a responder. The initiator is a device that plays a leading role in the distance-measurement communication. The division of roles in the distance-measurement communications may be modified as needed. Multiple anchors 2 may individually initiate and carry out the distance-measurement communication with the portable device 9. The distance-measurement communication may include a step where the initiator, prior to transmitting the pole signal, transmits a pre-pole signal for notifying of start of the distance-measurement. The distance-measurement communication may include a step where the initiator, after transmitting the final signal, transmits a final data signal being a UWB signal indicating that the distance-measurement has been performed successfully.

The NFC module 96 is a module for implementing NFC communications. The NFC module 96 is configured as a passive device that sends back a signal according to the content of data received from the NFC reader 4. The NFC module 96 is driven by the receiving power of the signal transmitted from the NFC reader 4 to generate and return a response signal. In a preferred example, the controller 943 of the present embodiment is configured to be able to perform NFC authentication process, which is user authentication using NFC. The NFC authentication process corresponds to a backup (i.e., alternative authentication method) in case of SRWC inability. The controller 943 may be configured to, even during the power saving mode described below, become activated upon the NFC module 96 receiving a signal from the vehicle Hv. The NFC module 96 is an optional element and may be omitted.

The indicator 97 is a light emitting part to notify the user of the remaining power of the battery 93. The remaining power is also referred to as SOC (State Of Charge). The remaining power (in other words, SOC) is the ratio of an actual remaining level a fully charged level The indicator 97 is configured to be capable of light up in multiple colors, e.g., red, yellow, and green. The indicator 97 lights up based on the controller 943′s instructions. The controller 943 may cause the indicator 97 to light up for a certain period of time (e.g., 5 seconds) in a manner corresponding to the remaining power, in response to the SRWC connection between the portable device 9 and the vehicle Hv. The controller 943 may light up the indicator 97 in red if the remaining power is less than 30%. The indicator 97 is an optional element and may be omitted.

### Portable Device Operating Mode

The portable device 9 has two operating modes: a normal mode and a power saving mode. The normal mode is a mode in which the controller 943 become active based on the output of the activation signal by the acceleration sensor 91 and tries to establish a wireless connection with the vehicle Hv. The normal mode may be understood as an operating mode applied in everyday use cases.

In contrast, the power saving mode is a mode in which the controller 943 does not become active even when vibrations corresponding to the acceleration above the activation threshold act on the portable device 9. This power saving mode can be interpreted as a mode in which the vibration acting on the portable device 9 does not cause the advertise to initiate. In the power saving mode, even if the vibration acts on the portable device 9. the SRWC module 94 and the UWB module 95 keep stopped. The power saving mode may be achieved by deactivating the acceleration sensor 91. In another embodiment, the power saving mode may be a state in which the acceleration sensor 91 is in operation but its output signal is nullified in the controller 943. The power saving mode may be a mode in which the controller 943 does not initiate the advertise even if the acceleration sensor 91 inputs the activation signal to the controller 943.

While in the normal mode, the portable device 9 transitions between four states: a first advertising state, a second advertising state, a connected state, and a sleep state. Triggers for state transitions may include vibration detection, communication connection with/disconnection from the vehicle Hv, etc.

The first advertising state is a state in which the SRWC module 94 performs the advertise at the given first interval. The first interval is set at 30, 50, or 60 milliseconds. The first interval may be set at a value in a range from a few 10 milliseconds to a few 100 milliseconds. The first advertising state is a state in which the advertise is performed at relatively high frequency. Performing the advertise at the first intervals is also referred to as fast advertise in the present disclosure.

The second advertising state is a state in which the advertise is performed periodically in a manner that consumes less power per unit time than the first advertising state. The second advertising state may be a state in which the advertise is performed at a second interval, where the first interval is longer than the first interval. The second interval may be set at 400 ms, 600 ms, 1 second, 2 seconds, or 3 seconds. The longer the advertisement interval, the lower the power consumption during standby. Performing the advertise at the second interval is also referred to as slow advertise in the present disclosure.

In the first advertising state, the advertise is performed frequently, so although power consumption is high, it is easier for the vehicle Hv to discover the portable device 9 (in other words, the user). In the second advertising state, power consumption is reduced, but it is difficult for the vehicle Hv to discover the portable device 9 (in other words, the user).

In the present disclosure, the first and second advertising states are also collectively described as vehicle search states. The vehicle search state corresponds to a periodic transmission mode. The vehicle search state may be interpreted as a state in which the SRWC module 94 is active and searching for the vehicle Hv. While the portable device 9 is in the first or second advertised state, the controller 943 may set the UWB module 95 into sleep. The sleep state of the UWB module 95 may be a state in which part or all functions of the UWB module 95 are stopped to reduce power consumption.

The connection state is the state in which the portable device 9 and the vehicle Hv have communication connection via SRWC. The portable device 9 transitions to the connection state upon receiving an advertise-related response (e.g., connection request) from the vehicle Hv. While in the connected state, the portable device 9 periodically performs data communication with the vehicle Hv. The controller 943 may transition the UWB module 95 into a state in which the UWB signal is transmittable and receivable, upon SRWC connection between the SRWC module 94 and the vehicle Hv. While in the connected state, the UWB module 95 performs the distance-measurement communications at a given interval, provided that the remaining power is above a given value. The connection state may include a distance-measurement state in which the UWB module 95 periodically performs the distance-measurement communications and a distance-no-measurement state in which the periodic distance-measurement communication is not performed.

The sleep state is a state in which the SRWC module 94 does not transmit the SRWC signal. The sleep state may be a state in which the acceleration sensor 91 keeps operating while the SRWC module 94 and UWB module 95 are stopped. Even in the sleep mode, the wireless power receiver 92 and the NFC module 96 can be driven by electric power received from outside. The charge controller 923 may be configured to become active and charge the battery 93 based on the input of a voltage above a given value from the rectifier circuit 922, even in the sleep state. In the sleep state, the portable device 9 is unable to communicate with the vehicle Hv, but power consumption can be reduced to a minimum.

The portable device 9 is configured to transition to the first advertisement state in response to detection of acceleration above a given activation threshold in the sleep state. The controller 943 is configured to become active and initiate the fast advertise upon input of the start signal from the acceleration sensor 91. In the present disclosure, the transition of the portable device 9 from the sleep state to the first advertising state is also referred to as wake (activation). The activation of the portable device 9 corresponds to the activation of the controller 943. The activation of the portable device 9 may be interpreted as the start of clock supply to the processor E1 provided by the controller 943. Paradoxically, the sleep state can be interpreted as a state in which the clock supply to processor E1 is stopped.

The portable device 9 automatically transitions to the second advertising state when the elapsed time from transitioning to the first advertising state becomes the given switchover time or more. In other words, the portable device 9 after wake-up transitions to the second advertising state automatically in the absence of receiving a connection request from the vehicle Hv after the elapse of the switchover time This reduces the advertisement interval from the first interval to the second interval and reduces power consumption. The switchover time may be set at 20 seconds, 30 seconds, 60 seconds, etc.

The active portable device 9 enters into the sleep state upon duration of a certain state reaches a stop time, the certain state being a state in which there is no detection of the acceleration above the sleep threshold. The sleep threshold may be the same value as the activation threshold, or may be smaller than the activation threshold. The sleep threshold may be a value corresponding to 50% or 25% of the activation threshold. In the following, the state in which the acceleration above the sleep threshold is not detected by the acceleration sensor 91 is also referred to as a motionless state. The stop time may be set to 60, 90, 120, 180, etc. seconds. In the present embodiment, the stop time is set longer than the switchover time. In another form, the stop time may be the same as or shorter than the switchover time. The switchover time and the stop time may be paraphrased as the first and second switchover times, respectively. After entering into the connection state, the portable device 9 transitions from the connection state to the sleep state upon duration of a certain state reaching a given time or upon receipt of a disconnect request signal requesting disconnection from the vehicle Hv, where the certain state is a state in which the SRWC signal is not received from the vehicle Hv.

The portable device 9 is configured to transition from the normal mode to the power saving mode upon the remaining power of the battery 93 falling below a given stop power. Specifically, when becoming active, the controller 943 acquires the output voltage of battery 93 If the output voltage is less than or equal to a given stop voltage, the controller 943 sets the portable device 9 into the power saving mode and stops operating. The process for transitioning to the power saving mode may include deactivating the acceleration sensor 91.

The process for transitioning to the power saving mode may include writing a code indicative of the power saving mode into the nonvolatile memory that retains operation setting (or activation condition) of the controller 943 (hereinafter referred to as “setting memory”). The setting memory may be provided using a storage area of the storage E3, or may a semiconductor memory that is on a circuit board and is separate from the storage E3. The portable device 9 may be configured to operate in the normal mode when the value of the mode setting of the portable device 9 is 0 in the setting memory, and to operate in the power saving mode when the value is 1. While the value of the mode setting is 1, the portable device 9 remains in the sleep mode, independent of the output of the acceleration sensor 91.

The stop voltage is designed based on discharge characteristics of the battery 93. The stop voltage may be 3.4 V, 3.6 V, 3.8 V, etc. The stop voltage may be set to a value greater than the end-of-discharge voltage. If the stop power is set to 20%, the stop voltage may be set to a value corresponding to SOC=20%. The stop voltage may be interpreted as a parameter that expresses the remaining power for transition to the power saving mode in terms of voltage value. Of course, the stop voltage may be a voltage value corresponding to SOC=10% or 25%. The stop voltage may be set to a value corresponding to a state where the SOC is between 5% and 30%.

Since the output voltage of the battery 93 corresponds to the remaining power of the battery 93, obtaining the output voltage corresponds to obtaining the remaining power. The expression “when the output voltage becomes less than or equal to the stop voltage” in the following may be read as “when the remaining power becomes less than the stop power”. In other words, the remaining power and the output voltage may be read interchangeably. The stop power is a value of the power corresponding to the stop voltage. The stop power is set to a value in a range between 5% and 30%, e.g., set to 10%, 20%, 25% etc. The stop voltage and the stop power correspond to a stop threshold. The stop voltage described above is a parameter that represents the stopping threshold in terms of voltage, and the stop power can be interpreted as a parameter that represents the stopping threshold in terms of remaining power (percentage).

The timing when the controller 943 obtains the output voltage may be changed as needed. The controller 943 may obtain the output voltage of battery 93 at the time when connected with vehicle Hv by SRWC. While in active, the controller 943 may also acquire the output voltage periodically (e.g., every 5 minutes). The controller 943 may acquire the output voltage in response to receiving a request from the vehicle Hv to initiate the distance-measurement communication. The controller 943 may implement a process for setting the portable device 9 into the power saving mode following detection that the output voltage is below the stop voltage.

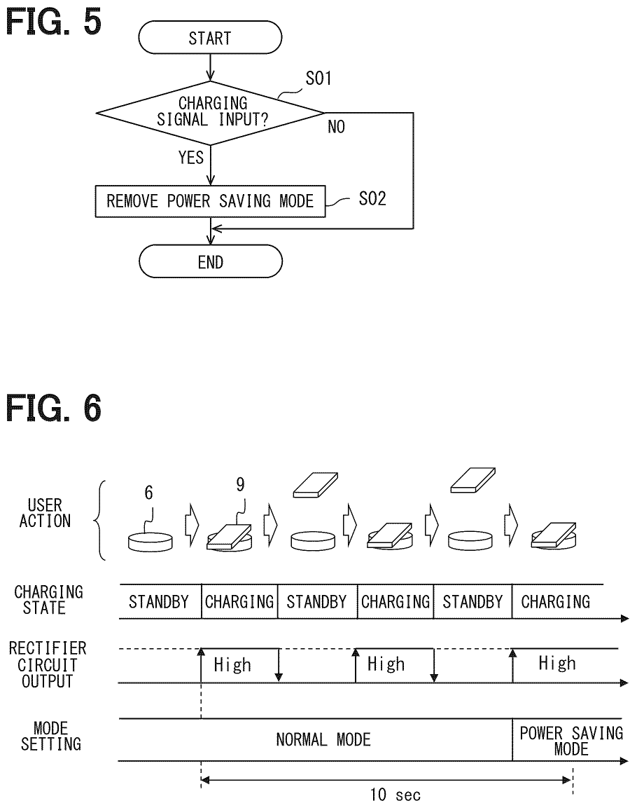

The portable device 9 may be configured to remove the power saving mode and return to the normal mode in response to start of the wireless charging, as shown in FIG. 5. Specifically, the controller 943 may be configured to become active based on the input of a high-level voltage signal from the rectifier circuit 922 (S01) and execute a process for returning to normal mode (S02). In the present disclosure, the high-level voltage signal output by the rectifier circuit 922 is also referred to as a charge signal. The process for returning to the normal mode may include enabling the acceleration sensor 91. The process for returning to the normal mode may include rewriting the value of the mode setting in the setting memory from a value corresponding to the power saving mode (e.g., 1) to a value corresponding to the normal mode (0).

The high-level voltage signal may be interpreted as a voltage signal with a magnitude greater than or equal to a given value. In the power saving mode, the controller 943 may be configured to become active in response to the input voltage from rectifier circuit 922 rising from a low level to a high level. An output terminal of the rectifier circuit 922 may be connected to a reset terminal of the controller 943 (e.g., MCLR terminal) via a high/low level inverting circuit.

The controller 943 may be configured to execute a process for setting the portable device 9 into the power saving mode when the output signal of the rectifier circuit 922 fluctuates in a given pattern, in addition to when the remaining power falls below a given value. The controller 943 may be configured to set the portable device 9 into the power saving mode when the number of times rise or fall of the output signal of the rectifier circuit 922 occurs within a certain period of time reaches a given value. The controller 943 may be configured to set the portable device 9 into the power saving mode upon detecting the rise of the output signal of the rectifier circuit 922 three times within 10 seconds, as shown in FIG. 6. According to this configuration, a user/administrator can forcibly set the portable device 9 into the power saving mode by repeating the operation of placing the portable device 9 on the wireless charger 6 the given number of times. The administrator may use the above operation to force the portable device 9 into the power saving mode during transportation of the portable device 9 from a manufacturing plant to a sales office. This further reduces remaining power consumption during transportation. The administrator herein may be understood as a person who manufactures or sells the portable device 9.

### Flow of Communications

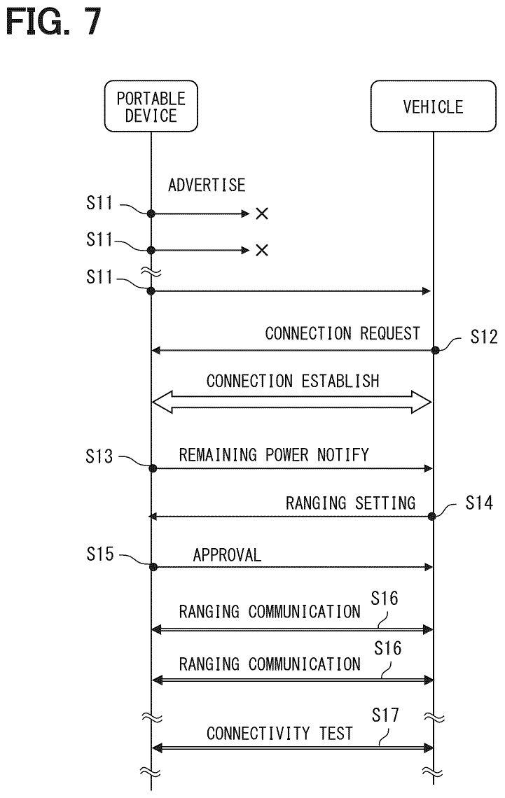

FIG. 7 is a diagram schematically illustrating a flow of communications between the portable device 9 and the vehicle Hv. At the time of starting the sequence shown in FIG. 7, the portable device 9 is far enough away from the vehicle Hv and has no communication connection with the vehicle Hv. The portable device 9 is in the normal mode.

When in the normal mode, the portable device 9, which is a peripheral, periodically transmits an advertise signal (S11) in response to the acceleration sensor 91 detecting a vibration. For a short period of time immediately after transmitting the advertise signal, the portable device 9 is in a receive standby state. As the user moves, the vehicle Hv may receive the advertise signal from the portable device 9 when the portable device 9 enters the SRWC area of the vehicle Hv. In response to receiving the advertise signal from the portable device 9, the vehicle Hv transmits a connection request signal to the portable device 9 (S12). This causes the portable device 9 and vehicle Hv to transition into a communication connected state. The communication connected state may be understood as a state in which the SRWC link has been established. The connection request signal is a signal requesting communication connection. In the present disclosure, the connection request signal may also be abbreviated as a connection request. In the communication connected state, the vehicle Hv and the portable device 9 transmit and receive a wireless signal for connectivity test at a given interval and perform encrypted data communication.

Upon establishing the communication connection with the vehicle Hv by SRWC, the controller 943 transmits data indicating the remaining power to the vehicle Hv by SRWC (S13). When the SRWC module 94 completes the communication connection with the vehicle Hv, the controller 943 exchanges a parameter for the distance-measurement communication (hereinafter, distance-measurement setting) with the vehicle Hv by SRWC as a preparatory process for the distance-measurement communication. The distance-measurement setting data is a data set including a distance-measurement parameter, which is a parameter for the distance-measurement communication. The distance-measurement setting data includes the execution interval of the distance-measurement communication.

The exchange of the distance-measurement setting may include a step in which the location determination device 1 transmits data indicating the desired distance-measurement setting (S14) and the portable device 9 approves the distance-measurement setting proposed by the location determination device 1 (S15). In the present embodiment, the location determination device 1 determines the values of various distance-measurement parameters, but not limited to this. Some or all of the distance-measurement parameters may be determined or proposed by the portable device 9. Step S15 may be a step where the portable device 9 transmits or proposes the distance-measurement setting to the location determination device 1.

Once the exchange of the distance-measurement setting, or in other words, the agreement of the distance-measurement setting, is completed, the portable device 9 periodically performs the distance-measurement communication with the vehicle Hv (S16). A single distance-measurement communication includes the portable device 9 and each anchor 2 transmit and receive a UWB signal for distance-measurement. The UWB signal for distance-measurement includes the prepole signal, the pole signal, the response signal, the final signal, and the final data signal described above. The controller 943 causes the UWB module 95 to perform the distance-measurement communications with each of the multiple anchors 2 in the manner following the distance-measurement setting.

The controller 943 also conducts data communication with the vehicle Hv for connectivity test at a given connection interval (S17). The data communication for connectivity test is carried out by SRWC. The connection interval is the interval of the data communication. The connection interval may be determined at the time of communication connection or pairing.

After the start of the distance-measurement communication, the portable device 9 and vehicle Hv repeat steps S16-S17 until a given end condition is met. If the end condition is met, the portable device 9 ends repetitive distance-measurement communication with the vehicle Hv and transitions into the sleep state. The end condition may be disconnection of the communication connection between the location determination device 1 and the portable device 9. The controller 943 can remove (i.e., disconnect) the connection with the vehicle Hv if a duration of a state of no receipt of the SRWC signal from vehicle Hv reaches a given time (e.g., Super Vision Time). The controller 943 may also determine that the end condition is satisfied when the end request signal is received from the vehicle Hv by SRWC. The controller 943 may determine that the end condition is met when the duration of the motionless state reaches the stop time. In another case, the controller 943 may determine that the end condition is met when the remaining power becomes equal to or less than the stop voltage. When the remaining power becomes equal to or less than the stop voltage, the controller 943 ends the distance-measurement communication and then executes the process for transition to the power saving mode.

### Example of Portable Device Operation

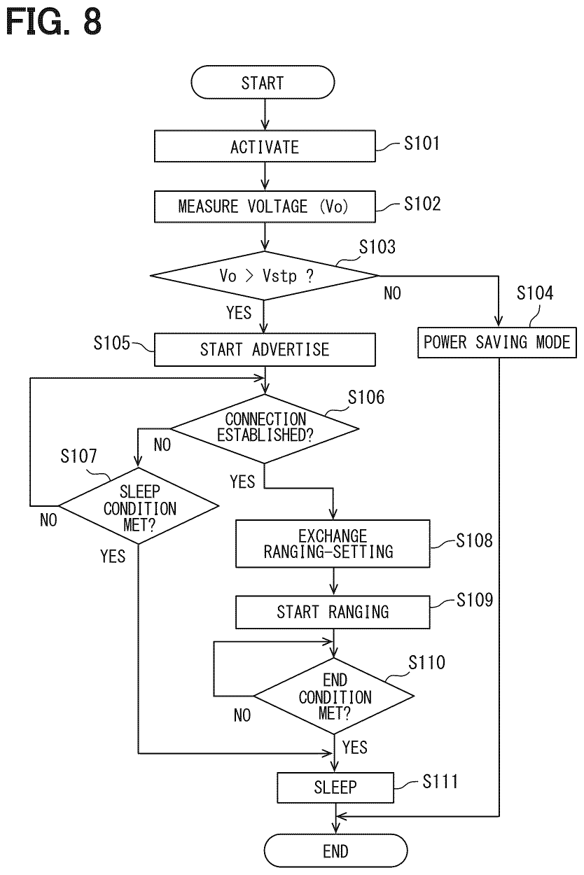

Now, the operation of the portable device 9 regarding mode switchover will be described using the flowchart shown in FIG. 8. A series of processes shown in FIG. 8 can be called a mode control process. The mode control process may include steps S101-S111 as shown in FIG. 8. Execution of the following process by the controller 933 in the description may be replaced with that by the processor E1, the SRWC module 94, or the portable device 9.

The flow shown in FIG. 8 may be started upon the controller 943 receiving an activation signal from the acceleration sensor 91, in other words, in response to the acceleration sensor 91 detecting acceleration above the activation threshold. As a preparation process for step S101, the mode control process may include a step in which the controller 943 determines whether an acceleration above the activation threshold is detected based on the output signal of the acceleration sensor 91. This preparation process may be performed periodically during the sleep state.

Step S101 is a step in which the controller 943 executes the activation process. The activation process is a process of transitioning from sleep state to a state in which the advertise is transmittable. The activation process may include: starting supply of the clock to processor E1; and reading by the processor E1 the program and/or the data for communication stored in storage E3 and storing it in the RAM 872. The activation process may also include starting supply of power to the RF core 942. Upon completion of step S101, the process proceeds to step S102.

Step S102 is a step in which the controller 943 acquires the output voltage of battery 93. Vo in the drawings represents the output voltage of the battery 93. Upon completion of step S102, the process proceeds to step S103.

Step S103 is a step in which the controller 943 determines whether or not the output voltage of battery 93 is greater than the stop voltage. Vstp in the drawings represents the stop voltage. If the output voltage is greater than the stop voltage (S103 YES), the process proceeds to step S105. If the output voltage is less than or equal to the stop voltage (S103 NO), the process proceeds to step S104.

Step S104 is the step in which the controller 943 performs a process for setting the portable device 9 into the power saving mode. The process for setting into the power saving mode may be deactivating the acceleration sensor 91 or rewriting the mode setting value in the setting memory, as described above. When the step S104 is completed, this flow ends.

Step S105 is a step in which the controller 943 starts the advertise in the first advertising state. This causes the SRWC module 94 to start transmitting the advertise signal periodically at the first intervals When the duration of the first advertising state becomes greater than or equal to the switchover time, the controller 943 switches the operating mode of the portable device 9 from the first advertising state to the second advertising state. In other words, the advertisement interval is changed from the first interval to the second interval. After step S105, the controller 943 performs advertise at the first or second interval until the sleep condition is satisfied or a communication connection is established with vehicle Hv. The sleep condition is a condition for the portable device 9 to transition into the sleep mode. The sleep condition may be that a duration of a state in which detection of the acceleration greater than or equal to the sleep threshold by the acceleration sensor 91 is absent reaches a stop time.

The controller 943 executes a determination process in step S106 each time the controller 943 performs the advertise. Step S106 is a step of determining whether not the communication connection with vehicle Hv by SRWC has been established. When the communication connection with the vehicle Hv has been established, the process proceeds to step S108. When the communication connection with the vehicle Hv has not been established, the process proceeds to step S107. The case of no communication connection with vehicle Hv is a case the connection request from vehicle Hv for the advertise is not received.

Step S107 is a step of determining whether or not the sleep condition is met. If the sleep condition is not satisfied, i.e., the duration of the motionless state has not reached the stop time, the controller 943 performs advertise after a given time and performs the connection determination in step S106. In the present disclosure, the advertise and the associated steps S106-S107 are collectively referred to as a vehicle search process. The vehicle search process may be executed repeatedly until the communication connection with the vehicle Hv is established or until the sleep condition is satisfied.

If the sleep condition is satisfied in step S107, i.e., the duration of the motionless state has reached the stop time, the controller 943 performs the process for transition to the sleep state (S111). The process for transition to the sleep state may be the process of stopping the operation of the SRWC module 94. The process for transition to the sleep state may be stopping the clock oscillator.

Step S108 is a step where the controller 943 exchanges the distance-measurement setting with the vehicle Hv by SRWC. Step S108 corresponds to steps S14-S15 above. When the exchange of distance-measurement setting is complete, the process moves to step S109. Step S109 is the step of starting the periodic distance-measurement communications. The periodic distance-measurement communication may be understood as the periodic (repetitive) execution of the distance-measurement communication according to the exchanged distance-measurement setting. In steps after step S109, it is determined whether or not the end condition is met. If the end condition is met, the portable device 9 enters into sleep mode (S111). Until the end condition is satisfied, the controller 943 repeatedly executes the distance-measurement communication (S16) and the data communication for connectivity test (S17), as described in FIG. 7.

The above control may be implemented using the remaining power (i.e., SOC) instead of the output voltage. Step S103 may be the step of determining whether or not the remaining power exceeds the stop power. In another example, while in operation, the controller 943 may periodically measure the output voltage of the battery 93. If the controller 943 detects that the measured output voltage is less than or equal to the stop voltage, the controller 943 may immediately execute the process (S104) for transition to the power saving mode. Each time the controller 943 measures the output voltage, the controller 943 may transmit data indicating the remaining power to the vehicle Hv by SRWC.

### Effect

The above-mentioned portable device 9 automatically switches its operating mode from the normal mode to the power saving mode based on that the remaining power in the battery 93 becomes less than a given value. The power saving mode is a mode in which the portable device 9 does not become active even when vibrations occur in the portable device 9. The above process can reduce a possibility that the battery 93 becomes an over-discharged state. The above process can extend the life of the battery 93 batteries.

Furthermore, the portable device 9 returns from the power saving mode to the normal mode in response to start of charging using the wireless charger 6. Therefore, there is no need for the user to operate a button on the portable device 9 to return the portable device 9 to the normal mode. The administrator can also return the portable device 9 to the normal mode in case of unintentional transition to the power saving mode due to power consumption during transportation, etc.

Based on the state of wireless charging, specifically, fluctuating the output signal of the rectifier circuit 922 a given pattern, the above-mentioned portable device 9 transitions to the power saving mode even when the remaining power is greater than or equal to a given value. Thus, the administrator can intentionally set the portable device 9 into the power saving mode, in cases of not use for a long period of time, such as during transportation. In addition, the button is not used to set into the power saving mode. Therefore, the portable device 9 do not have to include buttons. Since the portable device 9 of the present embodiment does not need to have buttons, the portable device 9 of the present embodiment can be downsized as compared with a portable device that has a button.

### Modified Example

The portable device 9 may be configured to remove the power saving mode not only when the wireless charging is started, but also when the remaining power becomes greater than or equal to a given return power. The return power may be set to a value that is greater than the stop power by a given amount. The given amount may be 5 percentage points (hereinafter pp), etc. The controller 943 may periodically measure the remaining power while wireless charging is initiated. The controller 943 can then perform the process for returning to the normal mode, upon detecting that the remaining power is greater than or equal to a return power due to the wireless charging. The return power and the stop power in the above description may be paraphrased as a return voltage and a stop voltage, respectively.

When the location determination device 1 has a communication connection with the portable device 9 by SRWC, the location determination device 1 may acquire data indicating the remaining power from the portable device 9 by SRWC. In that case, the location determination device 1 may display a remaining power notification image on the display 5. In other words, when the portable device 9 has a communication connection with the vehicle Hv by SRWC, the portable device 9 may transmit data indicating the remaining power to the vehicle Hv by SRWC and cause the remaining power notification image to be displayed on the display 5. The notification remaining power notification image is an image indicating the remaining power of the battery 93. The data indicating the remaining power may be the SOC value or the output voltage value of the battery 93. According to this configuration, the user can easily recognize the remaining power of the portable device 9. A form of the remaining power notification image may be changed according to the remaining power. As the remaining power decreases, the location determination device 1 may change the display into “High”, “Mid”, “Low”, and “Critical” in this order The location determination device 1 may display the remaining power notification image in a blinking manner when the remaining power is less than an emergency value. The emergency value may be the stop power plus a given value (e.g., 10 pp). If the stop power is 20%, the emergency value may be set to 30%, etc.

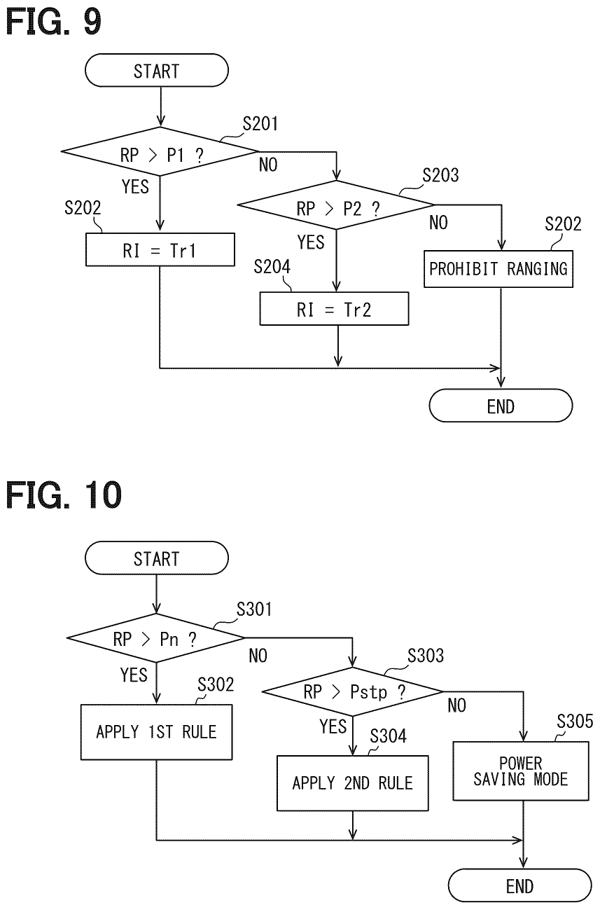

The location determination device 1 may change the interval at which the UWB the distance-measurement communication is performed, according to the remaining power of the battery 93. As shown in FIG. 9, if the remaining power is greater than the given first power (S201 YES), the location determination device 1 sets the distance measurement interval to a first distance measurement interval (S202). If the output power is less than or equal to a first power and is greater than a second power (S203 YES), the location determination device 1 sets the distance measurement interval to a second distance measurement interval (S204). If the output power is less than or equal to the second power (S203 NO), the location determination device 1 may prohibit the distance-measurement communications (S205).

In FIG. 9, “RP” represents the remaining power, “P1” represents the first power, and “P2” represents the second power. RI” represents the distance measurement interval actually applied, “Tr1” represents the first distance measurement interval, and “Tr2” represents the second distance measurement interval. The first and second powers are thresholds for the remaining power.

The first power may be set to a value corresponding to a state of sufficiently large remaining power. The first power may be set at 40% or 50%. The second power is a threshold value to protect the battery by stopping the distance-measurement communication. The second power may be set equal to the stop power. The second power may be greater than the stop power by 5 pp or 10 pp. The value of the remaining power to stop advertise and the value of the remaining power to stop UWB distance-measurement may be different values.

The first distance-measurement interval may be 100 ms, 150 ms, or 200 ms, etc. The second distance-measurement interval may be set to a value that is relatively larger than the first distance-measurement interval, such as 500 milliseconds, 1 second, or 2 seconds.

By lengthening the distance-measurement interval as the remaining power decreases, the power consumption of the portable device 9 can be reduced. By setting the distance-measurement interval to a relatively short value when there is sufficient remaining power, it is possible to enhance system responsiveness to the user's approach to the vehicle Hv and user convenience. Also, by stopping the distance-measurement communications when the remaining power is extremely low, the risk of the battery 93 reaching an over-discharged state can be reduced. In the above, the location determination device 1 determines the distance-measurement interval; alternatively, the adjustment of the distance-measurement interval according to the remaining power may be performed by the portable device 9.

In addition, the portable device 9 may change a rule for executing the advertise, according to the remaining power, as shown in FIG. 10. Specifically, if the remaining power is greater than a given normal operating power (Pn) (S301 YES), the controller 943 executes the advertise in a manner according to the given first rule (S302). Pn″ in the drawings represents the normal operating power. The normal operating power is a threshold for the remaining power.

The first rule may be, for example, such that the advertise is performed at the first interval until the elapse of a given first switchover time, and then the advertise at the second interval is performed. The first rule may be, after becoming active, operating in the first advertising state for the first switchover time and then operating in the second advertising state. Of course, over time, the portable device 9 enters into the sleep mode when the sleep condition is satisfied. The portable device 9 may also transition to the connected state upon receiving a connection request from the vehicle Hv. The first switchover time is a parameter corresponding to the aforementioned switchover time. The first switchover time corresponds to a first period.

The normal operating power may be set at 25%, 30%, or 35%, etc. The normal operating power is set at a value that is less than the first power by a given amount (5 or 10 pp). In a configuration where the first power is set at 35%, the normal operating power may be set at 30% or 25%. In another embodiment, the normal operating power may be the same as the first power.

If the output power is less than or equal to the normal operating power and greater than the stop power (S303 YES), the location determination device 1 performs the advertise in a manner according to a given second rule (S304). The “Pstp” in the FIG. represents the stop power.

The second rule is set to cause power consumption less than the first rule. For example, the second rule may cause, after becoming active, operating in the second advertising state for a second switchover time and then operating in the first advertising state. The second switchover time is set shorter than the first switchover time. If the first switchover time is 30 seconds, the second switchover time may be set to 15 seconds. The second rule may be a rule so that duration of the first advertised state is shorter as compared with the first rule. The second switchover time corresponds to the second period. When the second rule is applied, the controller 943 may perform the fast advertise until elapse of the second switchover time and then perform the slow advertise. When the output power is less than or equal to the stop power (S303 NO), the portable device 9 transitions from the normal mode to the power saving mode (S305).

The second rule may be cause performing the slow advertise immediately after becoming active without via the first advertisement state. The second rule may cause operating in a third advertised state after becoming active. The third advertising state may be a state in which the advertise is periodically executed in such a manner that power consumption per unit of time is reducible as compared with the second advertising state.

The third advertise state may be a state in which the advertise is performed at a third interval longer than the second interval. The third interval may be 4, 6, or 10 seconds, etc. In the present disclosure, performing the advertise in the third interval is also referred to as very slow advertise.

According to the above configuration, communication connectivity is enhanced by performing high frequency advertise when there is sufficient remaining power. Herein, the communication connectivity can be understood as a metric as to capability of establishing communication connection. If the remaining power is not sufficient, the frequency of the advertise is reduced, so that the decrease in remaining power is reduced. Furthermore, if the remaining power is extremely low, the transition to the power saving mode occurs so as not to perform the advertise, and therefore, the battery can be protected. According to the above configuration, the system responsiveness to the user's approach to the vehicle Hv decreases as the remaining power decreases. The reduced responsiveness makes it easier for users to notice the decrease in remaining power.

The various controls described above may be implemented using the output voltage instead of the remaining power (specifically, SOC). Steps S201, S203, S301, and S303 may be steps including comparing the output voltage to a given threshold value. The controller 943 may be configured to implement a combination of multiple controls, such as changing the distance-measurement interval according to the remaining power and changing the rule for executing the advertise.

The second advertising state is not limited to the state with an advertising interval is extended as compared with the first advertising state. The reduction in the power consumption may be achieved by reduction in transmit power of the advertise signal. The second advertising state may be a state in which the transmit power of the advertise signal is reduced by a given amount as compared with the first advertising state. In that case, the advertisement intervals in the first and second advertisement states may be the same. This setting provides the same effect as the above embodiment.

The third advertising state may be a mode in which the transmit power is reduced by a given amount as compared with the second advertising state. When the second advertising state is a state in which the advertise signal is periodically transmitted at the first transmission power and at the second interval, the third advertising state may be a state in which the advertise signal is periodically transmitted at the second transmission power and at the second interval. The first transmit power is the transmit power in the first advertising state. The second transmit power may be set to a value smaller than the first transmit power.

In the present disclosure, the operating mode in which the first rule is applied after the controller 943 becomes active is referred to as a standard mode, and the operating mode in which the second rule is applied is also referred to as a restricted mode. In other words, the operating mode of the portable device 9 may include the standard mode, the restricted mode, and the power saving mode. The standard mode corresponds to the first mode and the restricted mode corresponds to the second mode. The power saving mode corresponds to the third mode. The standard mode and the restricted mode can be understood as operating modes that are subdivisions of the normal mode. If the remaining power is greater than the normal operating power, the portable device 9 may operate in the standard mode, and if the remaining power is less than or equal to the normal operating power and greater than or equal to the stop power, the portable device 9 may operate in the restricted mode. The threshold for returning from the restricted mode to the standard mode may be set to a value that is greater than the threshold for transitioning from the standard mode to the restricted mode by a given amount. In a configuration where the portable device 9 has the restricted mode, the controller 943 may be configured to transition from the power saving mode to the restricted mode when the wireless charging has started or when the remaining power becomes greater than or equal to a given return power.

The controller 943 may estimate the remaining power based on the output voltage of the battery 93. An estimation method of the remaining power (i.e., SOC) is not limited to the OCV (Open Circuit Voltage) method. The controller 943 may estimate the remaining power by a current integration method (coulomb counting method) or an impedance track method. The controller 943 may estimate the remaining power by any estimation method. The controller 943 may set the operating mode of the portable device 9 into the power saving mode based on that the estimated value of the SOC is less than a given value.

Some of the functions of controller 943 may be provided by an IC/processor located outside of the SRWC module 94. The controller 943 may be located outside of the SRWC module 94. The arrangement of functions within the portable device 9 may be modified as needed. The portable device 9 may include one or more push switches in another embodiment.

A method of data communication between the portable device 9 and the location determination device 1 is not limited to Bluetooth LE, but may be Bluetooth Classic, Wi-Fi (registered trademark), EnOcean (registered trademark), Zigbee (registered trademark), etc. The wireless protocol used for the data communication (communication connection) may be paraphrased as a first wireless protocol, and the wireless protocol used for the distance-measurement communication may be paraphrased as the second wireless protocol.

The distance-measurement communication is not limited to UWB-IR, but may be performed using Bluetooth LE, Wi-Fi, etc. For example, the distance-measurement method using Bluetooth LE may be CS (Channel Sounding) distance-measurement. The CS distance-measurement is a method of measuring distance based on the difference in received phases for respective channels, obtained by transmitting and receiving CW (Continuous Wave) signals on multiple channels. The CS distance measurement is sometimes called High Accuracy Distance Measurement (HADM) or phase difference distance measurement.

### Appendix (1)

The present disclosure also includes the following technical ideas and configurations. The present disclosure also includes a mode control method, a computer program, and a storage medium storing the computer program, corresponding to the following technical ideas.

(Technical Idea 1). A portable device that functions as a wireless key for a door and operates on a secondary battery (93) includes:
a wireless communicator (94) for performing wireless communication with a system that controls a lock state of the door; and
a controller (943) that controls the wireless communicator,
wherein the controller is configured to perform:
by using the wireless communicator, transmitting an advertise signal being a wireless signal for establishing communication connection with the system;
acquiring data indicating a remaining power of the secondary battery; and
changing an operating mode of the portable device based on the remaining power, wherein the operating mode relates to transmission of the advertise signal.

(Technical Idea 2). The portable device according to Technical Idea 1 further includes:
a wireless power receiver (92) that charges the secondary battery using power transmitted wirelessly from an external wireless charger; and
a vibration sensor (91) that detects vibration,
wherein the operating mode includes,
a normal mode in which the wireless communicator transmits the advertise signal based on that the vibration is detected by the vibration sensor, and
a power saving mode in which the wireless communicator does not transmit the advertise signal even when the portable device vibrates,
wherein the controller is configured to:
set the portable device into the power saving mode in response to the remaining power falling below a stop threshold; and
remove the power saving mode based on receipt of the power from the wireless charger.

(Technical Idea 3). In the portable device according to Technical Idea 2,
the portable device has no push switch,
the wireless power receiver includes a rectifier circuit (922) that generates DC current based on the power received from the wireless charger, and
the controller is configured to set the portable device into the power saving mode based on that an output level of the rectifier circuit has fluctuated in a given pattern.

(Technical Idea 4). In the portable device according to any one of Technical Ideas 1-3,
the controller is configured to perform changing whether or not to transmit the advertise signal, based on the remaining power.

(Technical Idea 5). In the portable device according to any one of Technical Ideas 1-4,
the operating mode includes a periodic transmission mode in which the wireless communicator periodically transmits the advertise signal, and
the controller is configured to:
change a transmission interval of the advertise signal in the periodic transmission mode based on the remaining power.

(Technical Idea 6). The portable device according to any one of Technical Ideas 1-5 further includes:
a vibration sensor that detects vibration,
wherein the operating mode includes:
a first mode in which the wireless communicator repeatedly transmits the advertise signal according to a given rule in response to the vibration sensor detecting the vibration;
a second mode in which the wireless communicator repeatedly transmits the advertise signal according to a rule that can suppress power consumption more than the first mode, in response to the vibration sensor detecting the vibration; and
a third mode in which the wireless communicator does not transmit the advertise signal even when the portable device vibrates,
wherein the controller is configured to select the operating mode from among the first mode, the second mode and the third mode according to the remaining power.

The third mode described above may be a mode in which the wireless communicator does not transmit the advertise signal regardless of an output of the vibration sensor, or in which the vibration sensor is stopped. The third mode corresponds to the power saving mode described above.

(Technical Idea 7). In the portable device according to Technical Idea 6:
in the first mode, the wireless communicator starts repeatedly transmitting the advertise signal at a given first interval in response to the vibration sensor detecting the vibration; and
in the second mode, the wireless communicator starts repeatedly transmitting the advertise signal at a second interval longer than the first interval in response to the vibration sensor detecting the vibration.

(Technical Idea 8). In the portable device according to Technical Idea 7:
in the first mode, the wireless communicator performs operation including repeatedly transmitting the advertise signal at a given first interval for a given first period after detection of the vibration by the vibration sensor and then changing the transmission interval of the advertise signal to a second interval longer than the first interval; and
in the second mode, the wireless communicator performs operation including repeatedly transmitting the advertise signal at the first interval for a second period shorter than the first period after detection of the vibration by the vibration sensor and then changing the transmission interval of the advertise signal to the second interval.

(Technical Idea 9). In the portable device according to any one of Technical Ideas 6-8,
in the third mode, the vibration sensor is deactivated.

(Technical Idea 10). In the portable device according to any one of Technical Ideas 1-9,
the wireless communicator is a first communicator that performs data communication with the system by a given first wireless protocol,
the portable device further including:
a second communicator (95) configured to perform, for distance measurement, distance measurement communication with the system by a second wireless protocol different from the first wireless protocol,
wherein the controller is configured to: determine, based on the remaining power, whether or not to cause the second communicator to perform the distance-measurement communication; or determine, based on the remaining power, an execution interval of the distance-measurement communication.

(Technical Idea 11). In the portable device according to Technical Idea 10,
the first wireless protocol is Bluetooth (registered trademark) Low Energy; and
the second wireless protocol is Ultra Wide Band-Impulse Radio.

(Technical Idea 12). The portable device according to any one of Technical Ideas 1-11 further includes:
a vibration sensor that detects vibration,
wherein the controller is configured to:
become active in response to the vibration sensor detecting vibration; and
specify the remaining power based on the output voltage of the secondary battery.

(Technical Idea 12A). In the portable device according to any one of Technical Ideas 1-12,
the controller is configured to transmit data indicating the remaining power to the system using the wireless communicator based on establishment of the communication connection with the system.

(Technical Idea 12B). In the portable device according to any one of Technical Ideas 1-12,
the controller is configured to, using the wireless communicator, transmit a wireless signal to the system for displaying the remaining power on a display based on establishment of the communication connection with the system.

### Appendix (2)

Various flowcharts shown in the present disclosure are all examples, and the number of steps constituting the flowchart and the order in which the processes are executed can be changed as needed. The controls shown in respective flowcharts may be executed in combination/parallel to the extent that no contradiction occurs. The terms acquisition, determination, detection, generation, and calculation may be interchangeable. Acquisition of data by a device includes generation of such data by the device based on a signal input from another device/sensor. The present disclosure is applicable not only to systems that control lock/unlock of vehicles, but also to systems that control lock states of doors of buildings. The portable device 9 may be a wireless key for a building door, or a wireless key for a locker or other door.

The device, system, and method described in the present disclosure may be realized by a dedicated computer comprising a processor programmed to perform one or more functions embodied by a computer program. The device and method described in the present disclosure may be realized using a dedicated hardware logic circuit. The device and method described in the present disclosure may be realized by one or more dedicated computers comprising a combination of a processor executing a computer program and one or more hardware logic circuits. The processor may be any computing core, such as a CPU, MPU, GPU, or DFP (Data Flow Processor). Part or all of the functions provided by controller 943 may be realized as hardware. Part or all of the functions provided by the controller 943 may be realized using any of a system-on-chip (SoC: System-on-Chip), IC (Integrated Circuit), FPGA (Field-Programmable Gate Array). The same is true for the functions provided by the location determination device 1.

A computer program includes instructions executed by a computer. The computer program may be stored on a computer-readable non-transitory tangible storage medium. The storage medium for the computer program may be a variety of media, including hard disk drives (HDD), solid state drives (SSD), and flash memory.

What is claimed is:

1. A portable device that functions as a wireless key for a door and operates on a secondary battery, comprising:
a wireless communicator for performing wireless communication with a system that controls a lock state of the door; and
a controller, including a computer, that controls the wireless communicator,
wherein the controller is configured to perform:
by using the wireless communicator, transmitting an advertise signal being a wireless signal for establishing communication connection with the system;
acquiring data indicating a remaining power of the secondary battery; and
changing an operating mode of the portable device based on the remaining power, wherein the operating mode relates to transmission of the advertise signal.

2. The portable device according to claim 1, further comprising:
a wireless power receiver that charges the secondary battery using power transmitted wirelessly from an external wireless charger; and
a vibration sensor that detects vibration,
wherein the operating mode includes,
a normal mode in which the wireless communicator transmits the advertise signal based on that the vibration has been detected by the vibration sensor, and
a power saving mode in which the wireless communicator does not transmit the advertise signal even when the portable device vibrates,
wherein the controller is configured to:
set the portable device into the power saving mode in response to the remaining power falling below a stop threshold; and
remove the power saving mode based on receipt of the power from the wireless charger.

3. The portable device according to claim 2, wherein
the portable device has no push switch,
the wireless power receiver includes a rectifier circuit that generates DC current based on the power received from the wireless charger, and
the controller is configured to set the portable device into the power saving mode based on that an output level of the rectifier circuit has fluctuated in a given pattern.

4. The portable device according to claim 1, wherein
the controller is configured to change whether or not to transmit the advertise signal, based on the remaining power.

5. The portable device according to claim 1, wherein
the operating mode includes a periodic transmission mode in which the wireless communicator periodically transmits the advertise signal, and
the controller is configured to:
change a transmission interval of the advertise signal in the periodic transmission mode based on the remaining power.

6. The portable device according to claim 1, further comprising:
a vibration sensor that detects vibration,
wherein the operating mode includes:
a first mode in which the wireless communicator repeatedly transmits the advertise signal according to a given rule in response to the vibration sensor detecting the vibration;
a second mode in which the wireless communicator repeatedly transmits the advertise signal according to a rule that can suppress power consumption more than the first mode, in response to the vibration sensor detecting the vibration; and
a third mode in which the wireless communicator does not transmit the advertise signal even when the portable device vibrates,
wherein the controller is configured to select the operating mode from among the first mode, the second mode and the third mode according to the remaining power.

7. The portable device according to claim 6, wherein:
in the first mode, the wireless communicator starts repeatedly transmitting the advertise signal at a given first interval in response to the vibration sensor detecting the vibration; and
in the second mode, the wireless communicator starts repeatedly transmitting the advertise signal at a second interval longer than the first interval in response to the vibration sensor detecting the vibration.

8. The portable device according to claim 6, wherein:
in the first mode, the wireless communicator performs operation including repeatedly transmitting the advertise signal at a given first interval for a given first period after detection of the vibration by the vibration sensor and then changing the transmission interval of the advertise signal to a second interval longer than the first interval; and
in the second mode, the wireless communicator performs operation including repeatedly transmitting the advertise signal at the first interval for a second period shorter than the first period after detection of the vibration by the vibration sensor and then changing the transmission interval of the advertise signal to the second interval.

9. The portable device according to claim 6, wherein
in the third mode, the vibration sensor is deactivated.

10. The portable device according to claim 1, wherein
the wireless communicator is a first communicator that performs data communication with the system by a given first wireless protocol,
the portable device further comprising:
a second communicator configured to perform, for distance measurement, distance measurement communication with the system by a second wireless protocol different from the first wireless protocol,
wherein
the controller is configured to: determine, based on the remaining power, whether or not to cause the second communicator to perform the distance-measurement communication; or determine, based on the remaining power, an execution interval of the distance-measurement communication.

11. The portable device according to claim 10, wherein:
the first wireless protocol is Bluetooth (registered trademark) Low Energy; and
the second wireless protocol is Ultra Wide Band-Impulse Radio.

12. The portable device according to claim 1, further comprising:
a vibration sensor that detects vibration,
wherein
the controller is configured to:
become active in response to the vibration sensor detecting vibration; and
specify the remaining power based on the output voltage of the secondary battery.

13. A mode control method performed by a portable device that operates on a secondary battery and is configured to function as a wireless key for a door, comprising:
by using a wireless communicator, transmitting an advertise signal being a wireless signal for establishing communication connection with a system that controls a lock state of the door;
acquiring data indicating a remaining power of the secondary battery; and
changing an operating mode of the portable device based on the remaining power, wherein the operating mode relates to transmission of the advertise signal.
